(19) United States
(12) Patent Application Publication
(10) Pub. No.: US 2009/0172269 A1
(43) Pub. Date: Jul. 2, 2009

(54) NONVOLATILE MEMORY DEVICE AND ASSOCIATED DATA MERGE METHOD

(75) Inventors: Dong-Hyun SONG, Seoul (KR); Chan-Ik PARK, Seoul (KR); Sang-Ryul MIN, Seoul (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 12/347,243

(22) Filed: Dec. 31, 2008

Related U.S. Application Data
(63) Continuation-in-part of application No. 11/319,281, filed on Dec. 29, 2005, now Pat. No. 7,487,303.

(30) Foreign Application Priority Data
Feb. 4, 2005 (KR) 10-2005-10750

(51) Int. Cl. G06F 12/00; G06F 17/30; G06F 12/02; G06F 12/16

(52) U.S. Cl. 711/103; 707/204; 707/205; 711/166; 711/162; 711/206; 711/115; 711/E12.001; 711/E12.008; 711/E12.078; 707/E17.01

(57) ABSTRACT

A memory system is disclosed with a nonvolatile memory adapted to store a file system containing file system information, and a controller adapted to read the file system information and perform a merge operation.

### CROSS-REFERENCE TO RELATED APPLICATION

This is a continuation-in-part of application Ser. No. 11/319,281 filed on Dec. 29, 2005 which claims priority to Korean Patent Application No. 2005-10750 filed on Feb. 4, 2005. The subject matter of these two documents is hereby incorporated by reference.

### BACKGROUND

Embodiments of the present invention relate generally to a nonvolatile memory device. More particularly, embodiments of the invention relate to nonvolatile memory device and an associated data merge method.

Nonvolatile memory can be found in a wide variety of consumer and industrial electronic devices, such as personal computers, personal digital assistants, laptops, cellular phones, and cameras, to name but a few. Nonvolatile memory is particularly useful because of its ability to retain stored data even when power is cut off. Some of the advantages of nonvolatile memory include its speed of operation, its ruggedness, and low power consumption.

Conventional memory systems such as hard disks and floppy disk drives are not as rugged or power efficient as nonvolatile memory because they have moving parts that can be easily damaged. As a result, some conventional computer systems are replacing hard disk drives and floppy drives with nonvolatile memories.

Unfortunately, replacing a conventional disk drive with nonvolatile memory is not entirely straightforward. One reason is because data stored in a conventional disk drive can be overwritten in its current location, but data stored in a nonvolatile memory cannot be overwritten without first erasing an entire block of data. In other words, conventional disk drives have “write in place” capability, whereas nonvolatile memory does not. As a result, when a nonvolatile memory is required to coordinate with a host system that uses the memory access conventions of a conventional disk drive, the nonvolatile memory typically uses a translation layer (e.g., a flash translation layer or FTL), which is a driver that reconciles a logical address space used by the operating system with a physical address space used by the nonvolatile memory.

The translation layer generally performs at least three functions. First, it divides the nonvolatile memory into pages that can be accessed by the host system. Second, it manages data stored in the nonvolatile memory so that the nonvolatile memory appears to have write in place capability, when in reality, new data is written to erased locations of the nonvolatile memory. Finally, the translation layer manages the nonvolatile memory so that erased locations are available for storing new data.

Managing the nonvolatile memory involves various operations. For example, whenever a logical address is overwritten, a page of data stored at a corresponding physical address is invalidated and new page of data is stored at a new physical address of the nonvolatile memory. Whenever a sufficient number of pages in the nonvolatile memory are invalidated, the translation layer (e.g., a FTL) performs a “merge” operation whereby “valid” pages are transferred from source blocks containing invalid pages to destination blocks with available space. The purpose of the merge operation is to free up memory space occupied by invalidated blocks by erasing the source blocks.

The above operations describe how a translation layer typically works. A variety of different address translation schemes are disclosed, for example, in U.S. Pat. No. 5,404,485, U.S. Pat. No. 5,937,425, and U.S. Pat. No. 6,381,176.

A more detailed description of translation layer operations is presented below in the context of an electronic device comprising a host system connected to a nonvolatile memory. The nonvolatile memory comprises a plurality memory cells arranged in a memory cell array. The memory cell array is divided into a plurality of blocks, and each of the blocks is divided into a plurality of pages. The nonvolatile memory can be erased a block at a time, and it can be programmed or read a page at a time. However, once programmed, a page must be erased before it can be programmed again.

Within a nonvolatile memory (e.g., a flash memory), each block is designated by a physical block address, or “physical block number” (PBN) and each page is designated by a physical page address, or “physical page number” (PPN). However, the host system accesses each block by a logical block address, or “logical block number” (LBN) and each page by a logical page address, or “logical page number” (LPN). Accordingly, to coordinate the host system with the nonvolatile memory, the translation layer maintains a mapping between the logical block and page addresses and corresponding physical block and page addresses. Then, when the host system sends a logical block and page address to the nonvolatile memory, the translation layer translates the logical block and page address into a physical block and page address.

As mentioned previously, a merge operation is performed to consolidate valid pages within the nonvolatile memory, thereby freeing up space where invalid pages are located. When the merge operation is performed, the translation layer must maintain correct mappings between physical and logical block and page addresses. A merge operation typically comprises one or more of the following operations: a block mapping operation, a page mapping operation, and a log mapping operation.

An exemplary block mapping operation is described below in relation to Figure (FIG.) 1. Intuitively, a block mapping operation is simply a mapping of valid data contained in one block onto another block. One reason to perform a block mapping operation is to update a page within the block while maintaining the same relative locations for the pages. In FIG. 1, one page of a block is updated, and then all pages within the block are transferred to another block. When a block mapping operation occurs, a block mapping table keeping track of mappings between logical block numbers and physical block numbers is updated by the translation layer.

Referring to FIG. 1, first and second blocks with respective physical block numbers PBN2 and PBN3 each comprise a plurality of pages. Data stored in an “i^{th}” page of the first block is updated by programming a corresponding “i^{th}” page in the second block with new data while invalidating the “i^{th}” page in the first block. Then, all valid pages in the first block are transferred to the second block. The transfer of the valid pages is denoted in FIG. 1 by the symbol □. Once all pages in the first block have been transferred to the second block, the first block is erased.

FIG. 2 illustrates an exemplary page mapping operation. In a page mapping operation, pages are transferred to different physical page numbers and the translation layer updates a page mapping table to keep track of correspondences between logical and physical page numbers. FIG. 2A shows two memory blocks of a nonvolatile memory and FIG. 2B shows a page mapping table for the nonvolatile memory.

In FIG. 2, first and second program operations have been performed with each of logical page numbers 0 and 1. In the first program operations, logical page number 0 mapped to physical page number 0 and logical page number 1 mapped to physical page number 0. In the second program operations, logical page number 0 mapped to physical page number 4 and logical page number 1 mapped to physical page number 3. As a result, pages of data stored at physical page numbers 0 and 1 are invalidated, as illustrated by crossed out boxes in FIG. 2A.

To free up the memory space at physical page numbers 0 and 1, the page mapping operation transfers pages of data from a first block with physical block number PBN0 to a second block with physical block number PBN1. As a result, pages of data stored in the first block are stored at new physical page numbers in the second block while keeping the same logical page numbers. Then, once all valid data is transferred from the first block to the second block, the first block is erased.

FIG. 3 illustrates a log mapping operation, wherein pages of data from two different blocks are transferred to a single block. Referring to FIG. 3, a nonvolatile memory is divided into a data region, a log region, and a meta region.

The memory block shown in FIG. 3A comprises first through ninth physical memory blocks PBN0 through PBN8. Memory blocks PBN0-PBN4 are located in the data region, memory blocks PBN5-PBN7 are located in the log region, and a memory block PBN8 is defined in the meta region. It is assumed that memory blocks PBN5 and PBN6 in the log region correspond to respective memory blocks PBN0 and PBN2 and memory block PBN8 in the meta region is designated as an empty memory block.

Where the host system initiates a program operation for a page in memory block PBN0, data is programmed in a corresponding page in log block PBN5. However, where the host system initiates a program operation for a page in memory block PBN1, no corresponding block exists in the log region. Accordingly, to create space for a block corresponding to memory block PBN1, memory block PBN5 and PBN0 are merged by a log mapping operation.

In the log mapping operation, as illustrated in FIG. 3B, valid pages in memory blocks PBN5 and PBN0 are transferred to corresponding locations in a memory block PBN7. In the log mapping operation, the translation layer maintains a mapping table to keep track of the correspondences between logical and physical addresses of the blocks and pages in the nonvolatile memory.

One problem with conventional merge operations is that the host system can not determine when a merge operation occurs, since merge operations are determined by operations of the translation layer which are transparent to the host system. Since translation layer does not store information about a file system, such as a file allocation table, the translation layer can not determine whether the host system considers a page invalid. Accordingly, in some instances, a file system for the host system may mark certain pages for deletion without the awareness of the translation layer. As a result, a merge operation performed by the translation layer may copy pages that are invalid from the host system's point of view. As a result, the merge operation takes more time than it should, thus degrading the performance of the memory system.

### SUMMARY OF THE INVENTION

According to one embodiment of the invention, a memory system is provided. The memory system comprises a nonvolatile memory adapted to store file system information, and a controller adapted to read the file system information and perform a merge operation.

According to another embodiment of the invention, a method of performing a merge operation in a nonvolatile memory system comprising a nonvolatile memory and a controller is provided. The method comprises reading file system information from a file system region of the nonvolatile memory, and selectively copying a page from a first block in the nonvolatile memory to a second block in the nonvolatile memory based on the file system information.

### BRIEF DESCRIPTION OF THE DRAWINGS

The invention is described below in relation to several embodiments illustrated in the accompanying drawings. Throughout the drawings like reference numbers indicate like exemplary elements, components, or steps. In the drawings:

FIG. 1 is a block diagram illustrating a block mapping operation in a conventional nonvolatile memory system;

FIG. 2 is a block diagram illustrating a page mapping operation in a conventional nonvolatile memory system;

FIG. 3 is a block diagram illustrating a log mapping operation in a conventional nonvolatile memory system;

FIG. 4 is a block diagram of an electronic device comprising a host system and a nonvolatile memory system according to an embodiment of the present invention;

FIG. 5 is a block diagram illustrating a method of performing a merge operation in a nonvolatile memory system according to an embodiment of the present invention;

FIG. 6 is flowchart illustrating a selective merge method for a nonvolatile memory system according to an embodiment of the present invention.

FIG. 7 is a block diagram of a solid state drive (SSD) according to an embodiment of the present invention;

FIG. 8 is a schematic diagram illustrating the logical partitioning of a memory of a solid state drive;

FIG. 9 is a schematic diagram illustrating the structure of a Master Boot Record (MBR);

FIG. 10 is a schematic diagram illustrating a partition record contained in the MBR of FIG. 9;

FIG. 11 is a table illustrating partition types and corresponding ID values;

FIGS. 12 and 13 are a flow chart and schematic diagram, respectively describing a method of locating invalid data area according to an embodiment of the present invention;

FIGS. 14 and 15 are a flow chart and schematic diagram, respectively, describing a method of locating invalid data area according to an embodiment of the present invention;

FIGS. 16 and 17 are a flow chart and schematic diagram, respectively, for use in describing a method of locating invalid data area according to an embodiment of the present invention; and

FIG. 18 is a system level diagram of a memory system according to embodiments of the present invention.

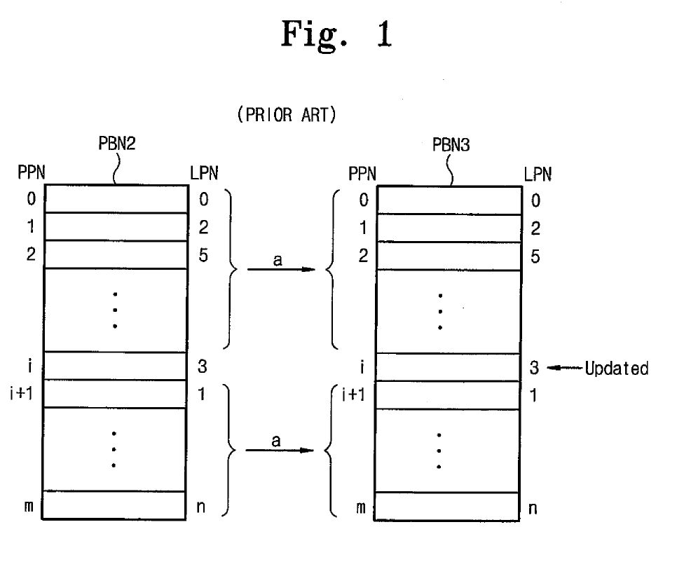

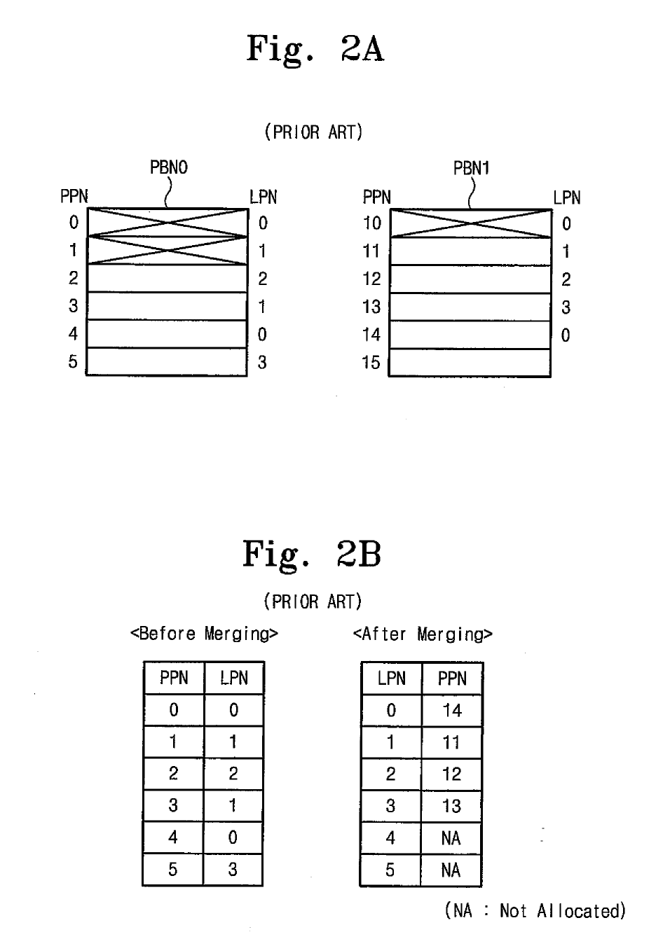

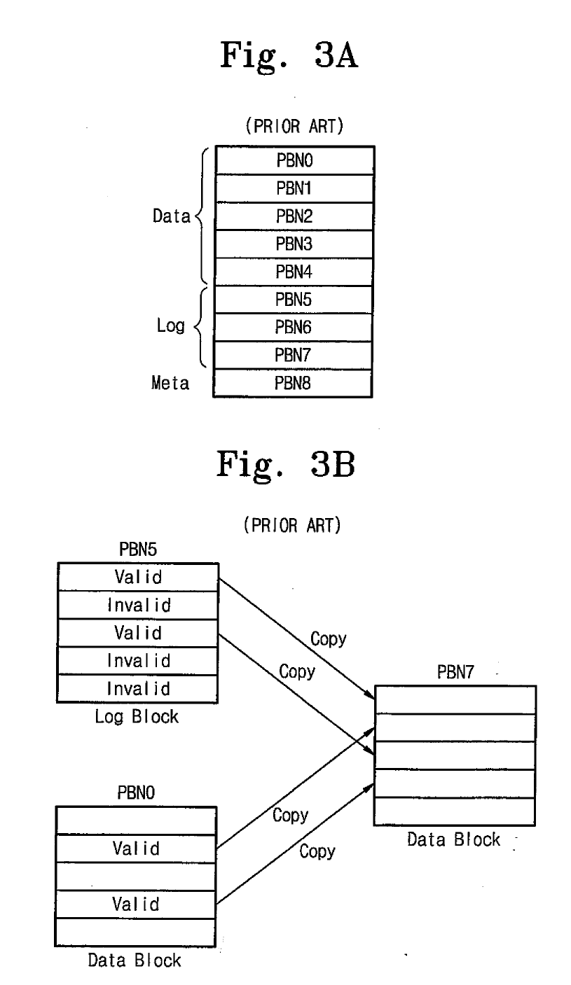

### DESCRIPTION OF EXEMPLARY EMBODIMENTS

Exemplary embodiments of the invention are described below with reference to the corresponding drawings. These embodiments are presented as teaching examples. The actual scope of the invention is defined by the claims that follow.

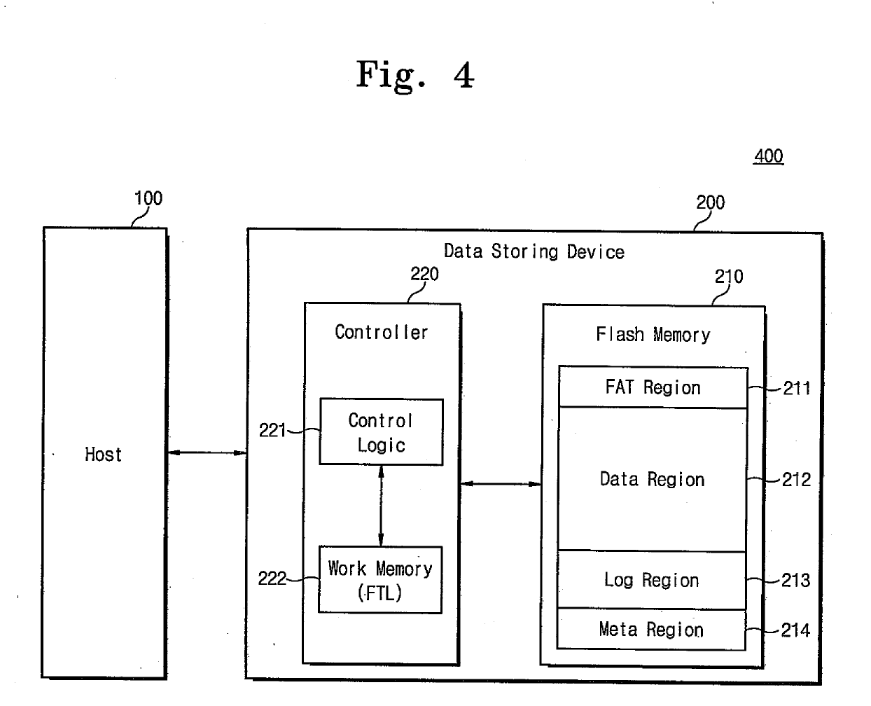

FIG. 4 is a block diagram of an electronic device 400 according to one embodiment of the invention. Referring to FIG. 4, electronic device 400 comprises a host system 100 and a memory system 200. Memory system 200 comprises a nonvolatile memory 210 and a controller 220 for interfacing between nonvolatile memory 210 and host system 100.

Flash memory 210 comprises a plurality of memory cells arranged in a memory cell array. The memory cell array is divided into a plurality of blocks, and each block is divided into a plurality of pages. Each page comprises a plurality of memory cells sharing a common wordline. Flash memory 210 is erased a block at a time, and read or programmed a page at a time. However, pages of nonvolatile memory 210 can only be programmed when in an erased state. In other words, nonvolatile memory 210 does not have “write in place” capability. Typically, nonvolatile memory 210 comprises a flash memory, such as a NAND flash memory.

Host system 100 accesses memory system 200 as if it were a conventional hard disk with write in place capability. Since nonvolatile memory 210 does not have write in place capability, controller 220 comprises a translation layer (e.g., a FTL when flash memory is used as the nonvolatile memory), which gives host system 100 the appearance of write in place capability while actually programming data to different pages of nonvolatile memory 210.

Nonvolatile memory 210 comprises a file system (e.g., a file allocation table or FAT) region 211 storing a file allocation table, a data region 212, a log region 213, and a meta region 214.

Log region 213 comprises a plurality of log blocks 213 corresponding to a plurality of respective data blocks in data region 212. Accordingly, when host system 100 initiates a program operation for a data block in data region 212, data for the program operation is programmed in a corresponding log block of log region 213.

Where a data block in data region 212 does not have a corresponding log block in log region 213, or where there is no empty page in a log block in log region 213, or where a host makes a merge request, a merge operation is performed. In the merge operation, valid pages of data blocks and corresponding log blocks are copied to new data and log blocks. Once the merge operation is performed, mapping information for logical addresses and physical addresses of nonvolatile memory 210 are stored in meta region 214.

Controller 220 is configured to control memory system 200 when host system 100 performs a memory access operation. As shown in FIG. 4, controller 220 comprises a control logic circuit 221 and a working memory 222. The translation layer is stored in working memory 222. When host system 100 initiates a memory access operation, control logic circuit 221 controls the translation layer.

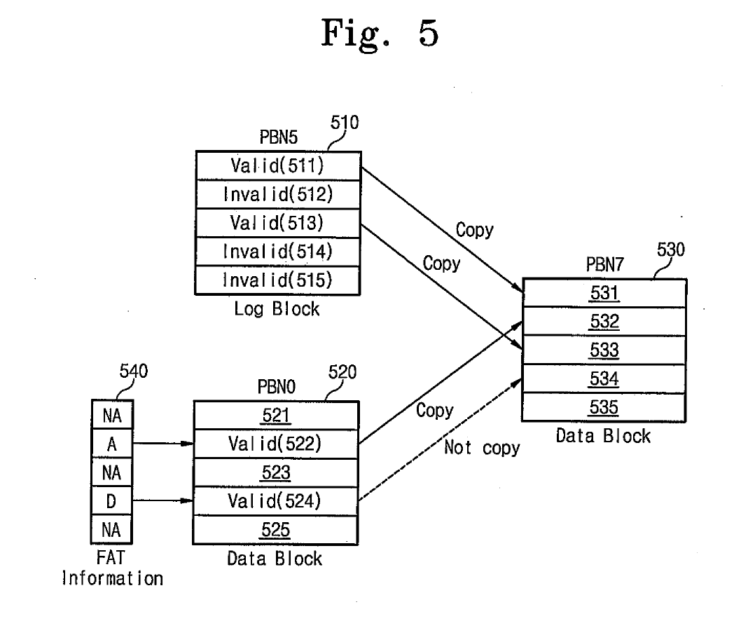

FIG. 5 is a block diagram illustrating a method of performing a merge operation in memory system 200 according to an embodiment of the present invention. Referring to FIG. 5, valid pages 511 and 513 of a log block 510 and a valid page 522 of a data block 520 are copied to a new data block 530. Pages 511 and 513 are respectively copied to pages 531 and 533 of data block 530, and page 522 is copied to a page 532 of data block 530. A valid page 524 in data block 520 is not copied to data block 530 based on file system information 540 stored in file system region 211.

File system information 540 indicates whether pages of data in data block 520 have been allocated by host system 100 or whether the pages have been marked for deletion. For instance, pages 521, 523, and 525 in data block 520 do not store any data, and therefore they are marked as Not Allocated (NA) in file system information 540. On the other hand, page 522 stores valid data, so it is marked as allocated (A). Page 524, however, stores valid data, but it is regarded by the host system as a deleted page, and therefore it is marked as Deleted (D). Since the host system regards page 524 as deleted, page 524 is not copied to block PBN7 in a merge operation.

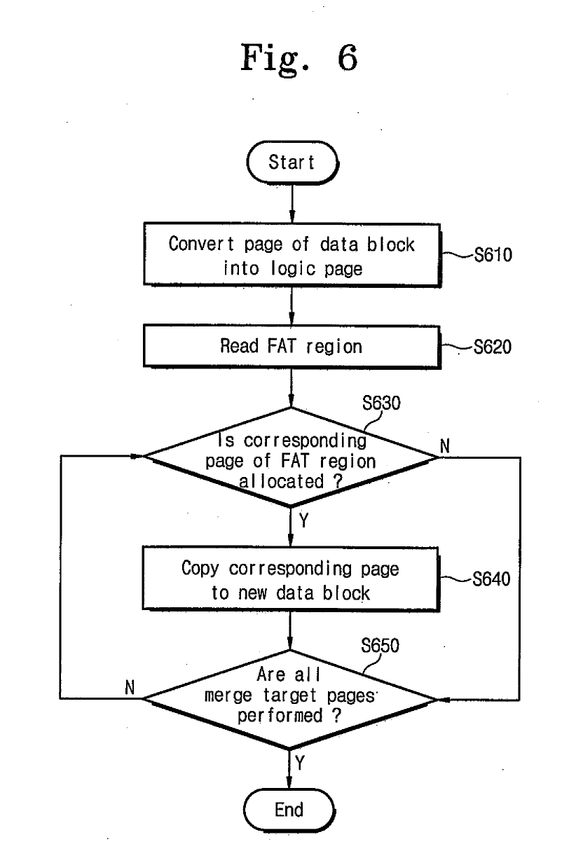

FIG. 6 is flowchart illustrating a method of performing a merge operation according to an embodiment of the present invention. The method is described in relation to the system illustrated in FIGS. 4 and 5. In the following description, exemplary method steps are denoted by parentheses (XXX) to distinguish them from exemplary system elements, such as those shown in FIG. 4.

Referring to FIG. 6, the method comprises converting a physical page of data block 530 into a logical page (S610), or in other words, associating an appropriate logical address used by host system 100 with data block 520. The method further comprises reading file system information 540 stored in file system region 211 using the translation layer (S620). The method further comprises determining whether a page in data block 520 corresponding to the logical page in data block 530 is valid and determining whether the page in data block 520 is allocated according to file system information 540 (S640). Where the page in data block 520 is a not allocated or it is marked for deletion in file system information 540, the page is not copied to data block 530. In contrast, where the page in data block 520 is valid and allocated according to file system information 540, the data block is copied to data block 530 (S640). After determining whether the page in data block 520 is valid or allocated, the method determines whether all pages in data block 520 have been checked by step S630 (S650). Where all of the pages in data block 520 have been checked, the method terminates. Otherwise, steps S630, S640, and S650 are repeated.

The method illustrated in FIG. 6 prevents data that has been marked for deletion by the host system from being copied to another memory block in a merge operation. As a result, the time required to perform the merge operation is reduced, and the overall efficiency of the memory system improves.

For example, referring to FIG. 5, assume that the number of valid/allocated pages in log block 510 is “x”, the number of valid/deleted pages is “y”, and the time required to copy one page is “z”. The total time required to perform a merge operation where the valid/deleted pages are copied is therefore (x+y)*z. However, by not copying the valid/deleted pages, the time to perform a merge operation is reduced by y*z.

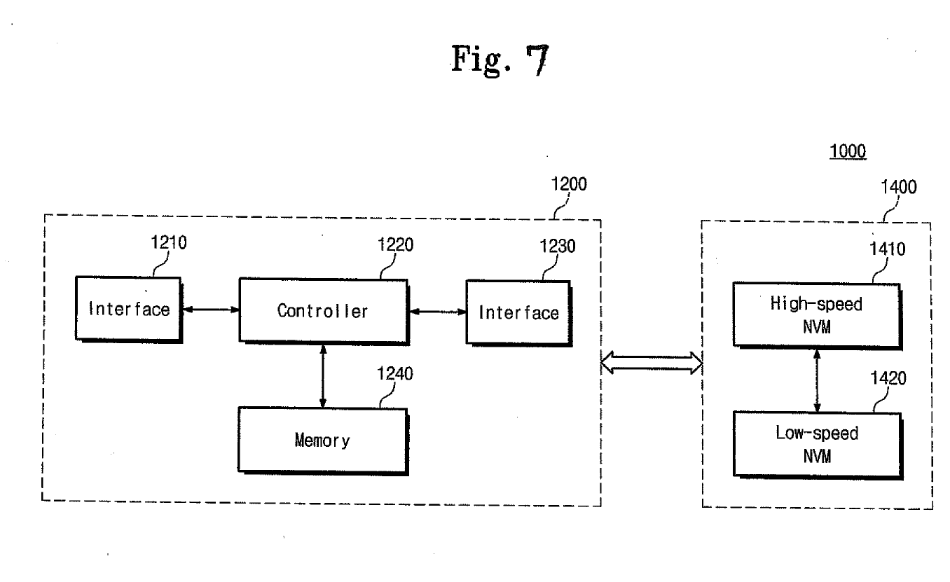

In relation to the forgoing certain additional embodiments of the invention are described with reference to FIGS. 7-18.

FIG. 7 illustrates a block diagram of a solid state drive (SSD) 1000 according to an embodiment of the present invention. As shown, the SSD 1000 of this example includes an SSD controller 1200 and non-volatile storage media 1400.

The SSD controller 1200 includes first and second interfaces 1210 and 1230, a controller 1220, and a memory 1240.

The first interface 1210 functions as a data I/O interface with a host device, such as a host central processing unit (CPU) (not shown). Non-limiting examples of the first interface 1210 include Universal Serial Bus (USB) interfaces, Advanced Technology Attachment (ATA) interfaces, Serial ATA (SATA) interfaces, Small Computer System Interface (SCSI) interfaces.

The second interface 1230 functions as a data I/O interface with the non-volatile storage media 1400. In particular, the second interface 1230 is utilized to transmit/receive various commands, addresses and data to/from the non-volatile storage media 1400. As will be apparent to those skilled in the art, a variety of different structures and configurations of the second interface 1230 are possible, and thus a detailed description thereof is omitted here for brevity.

The controller 1220 and memory 1240 are operatively connected between the first and second interfaces 1210 and 1230, and together function to control/manage the flow of data between the host device (not shown) and the non-volatile storage media 1400. The memory 1240 may, for example, be a DRAM type of memory device, and the controller 1220 may, for example, include a central processing unit (CPU), a direct memory access (DMA) controller, and an error correction control (ECC) engine. Examples of controller functionality may be found in commonly assigned U.S. Patent Publication 2006-0152981, which is incorporated herein by reference. The operations generally executed by controller 1220 (and memory 1240) to transfer data between the host device (not shown) and SSD memory banks are understood by those skilled in the art, and thus a detailed description thereof is omitted here for brevity. Rather, the operational description presented later herein is primarily focused on inventive aspects relating to various embodiments of the invention.

Still referring to FIG. 7, the non-volatile storage media 1400 of this example includes a high-speed non-volatile memory (NVM) 1410 and a low-speed non-volatile memory (NVM) 1420. However, the embodiments herein are not limited configurations containing dual-speed memories. That is, the non-volatile storage media 1400 may instead be composed of a single type of memory operating at a single speed.

As the names suggest, the high-speed NVM 1410 is capable of operating at a relatively higher speed (e.g., random write speed) when compared to the low-speed NVM 1420.

In an exemplary embodiment, the high-speed NVM 1410 is single-level cell (SLC) flash memory, and the low-speed NVM 1420 is multi-level cell (MLC) flash memory. However, the invention is not limited in this respect. For example, the high-speed NVM 1410 may instead be comprised of phase-change random access memory (PRAM), or MLC nonvolatile memory in which one bit per cell is utilized. Also, the high-speed NVM 1410 and the low-speed NVM 1420 may be comprised of the same type of memory (e.g., SLC or MLC or PRAM), where the operational speed is differentiated by fine-grain mapping in the high-speed NVM 1410 and coarse-grain mapping in the low-speed NVM 1420.

Generally, the high-speed NVM 1410 is utilized to store frequently accessed (written) data such as metadata, and the low-speed NVM 1420 is utilized to store less frequently accessed (written) data such as media data. In other words, as will discussed later herein, a write frequency of data in the high-speed NVM 1410 is statistically higher than a write frequency of data in the low-speed NVM 1420. Also, due to the nature of the respective data being stored, the storage capacity of the low-speed NVM 1420 will typically be much higher than that of the high-speed NVM 1410. A more detailed discussion of examples in which high-speed and low-speed memories are efficiently utilized to store different types of data can be found in commonly assigned U.S. Non-provisional application Ser. No. 12/015,548, filed Jan. 17, 2008, the subject matter of which is hereby incorporated by reference. Again, however, the embodiments herein are not limited to the use of two or more memories operating at different speeds.

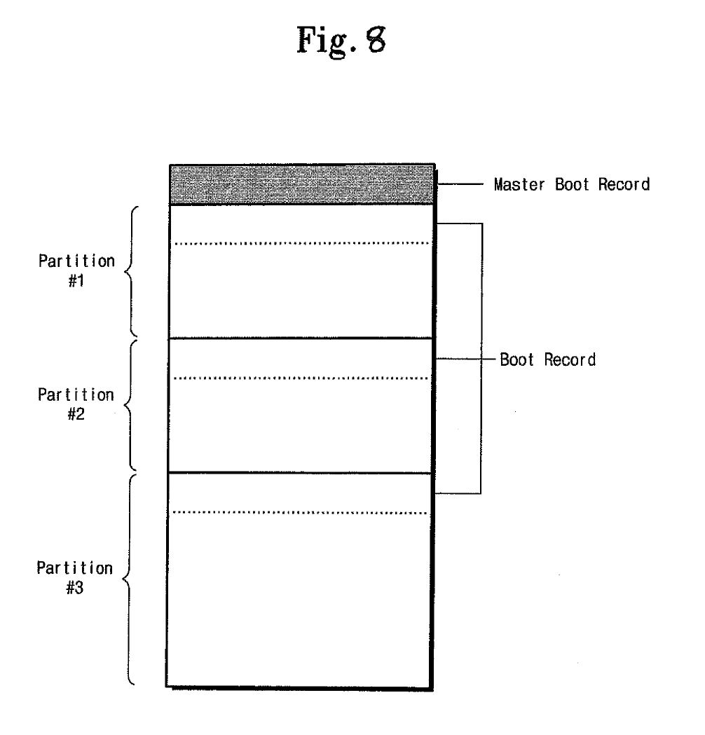

FIG. 8 illustrates an example of the logical partitioning of the non-volatile storage media 1400. As shown, the first “sector” of the solid-state memory contains a master boot record (MBR), and remaining sectors of the memory are divided into a number of partitions. In addition, each partition generally includes a boot record at a logical front end thereof.

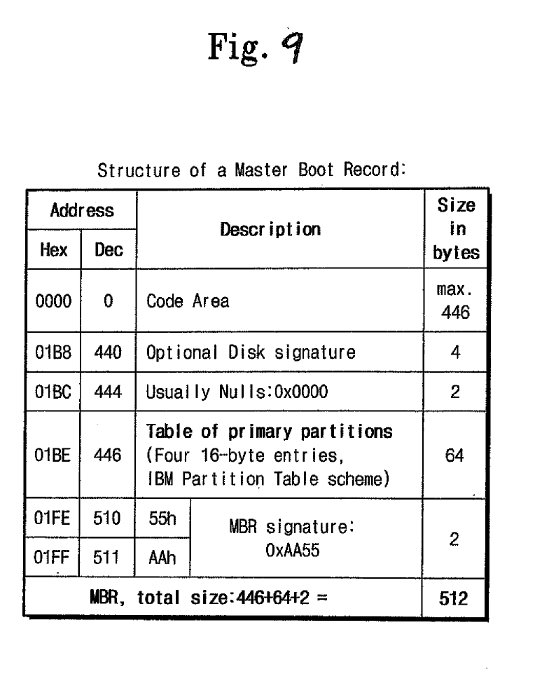

FIG. 9 illustrates a well-known 512-byte example of the MBR shown in FIG. 8. Generally, the MBR is utilized, for example, to maintain the primary partition table of the solid-state memory. It may also be used in bootstrapping operations after the computer system's BIOS transfers execution to machine code instructions contained within the MBR. The MBR may also be used to uniquely identify individual storage media.

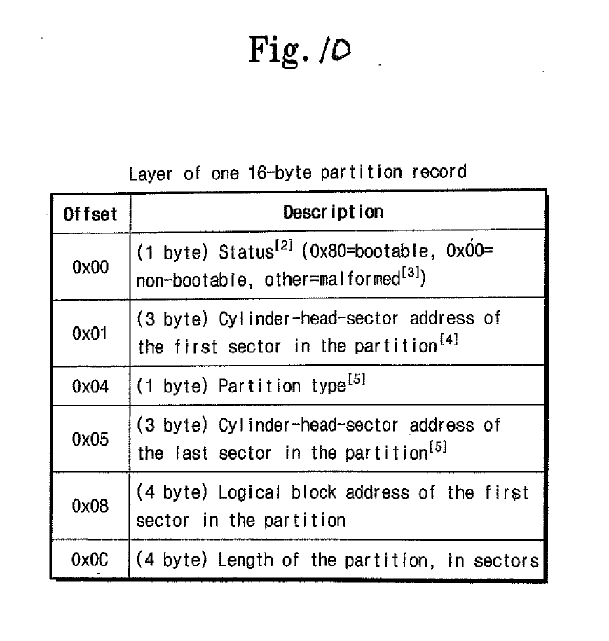

FIG. 10 illustrates an example of the layout of a single 16-byte partition record of the MBR illustrated in FIG. 9. In the example of the IBM Partition Table standard, four (4) of the partition records illustrated in FIG. 10 are contained with the partition table of the MBR.

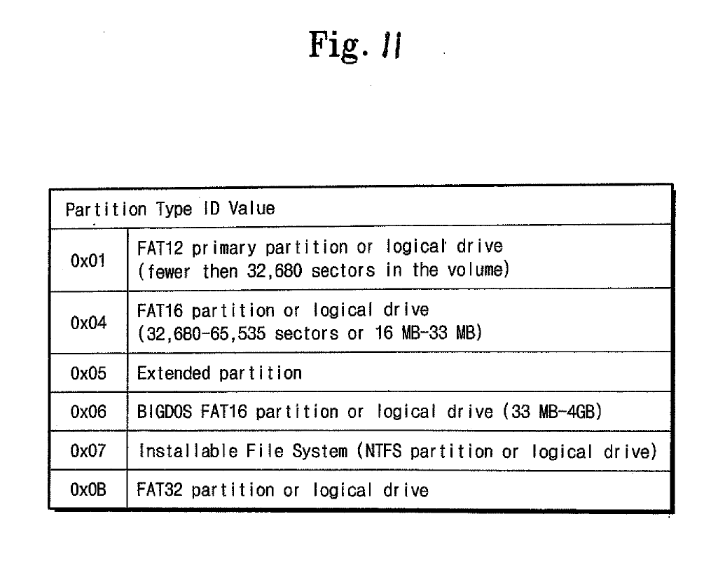

FIG. 11 is a table illustrating partition types and corresponding ID values. In this respect, the Operating System (O/S) of can additionally create a plurality of partition in specified primary partition. These partitions are referred to as “Extended Partition”. Each partition created on extended partition is called as logical partition, and each logical partition can adapt the same or different file system.

It is noted here that the above-described MBR scheme represents just one of several standards in an ever-evolving industry. For example, the Extensible Firmware Interface (EFI) standard has been proposed as a replacement for the PC BIOS standard. Whereas PC BIOS utilizes the MBR scheme as described above, the EFI standard utilizes a GUID Partition Table (GPT) as the standard for the layout of a partition table in a logically partitioned solid-state drive. The present invention is not limited to any particular partitioning standard.

Data contained in the MBR's (or GUID) partitioning table of FIG. 9 is an example of “storage-level” metadata, i.e., metadata associated with logical storage areas of the solid state memory. This is in contrast with “file system level” metadata which is metadata associated with the file system of the computer system. File system examples include File Allocation Table (FAT), New Technology File System (NTFS), Second and Third Extended File Systems (ext2 and ext3).

That is, when a user deletes a file in the solid state memory 1400, the file system running on the system processes the delete command and, from the user's point of view, appears to remove the file from memory 1400. In reality, however, conventional file systems leave the file data in physical memory, and instead, the data is deemed “invalid”. A host system includes an application program that communicates with a file system. A Translation Layer (e.g., a FTL) keeps track of the physical location of memory units associated with files in the solid state memory 1400 so the file system need only reference logical memory units.

As will be explained in more detail below, embodiments of the invention are at least partially directed to monitoring updated metadata in order locate the positions of invalid data stored in the solid state memory system.

The metadata that is monitored may be storage level metadata or file system level metadata. In the case of storage level metadata, for example, the metadata may be contained in a partition table, and invalid data is located in accordance with changes in the metadata of the partition table.

In one embodiment, for example, a determination is made as whether partition metadata of the solid state memory has changed, and if so, the partition metadata is analyzed to locate invalid data stored in the solid state memory. This analysis may include determining that a file system type of a partition has changed, and invalidating data in response to the changed file system type. Alternately, or in addition, the analysis may include determining that a partition has changed, and invalidating data in response to the changed partition.

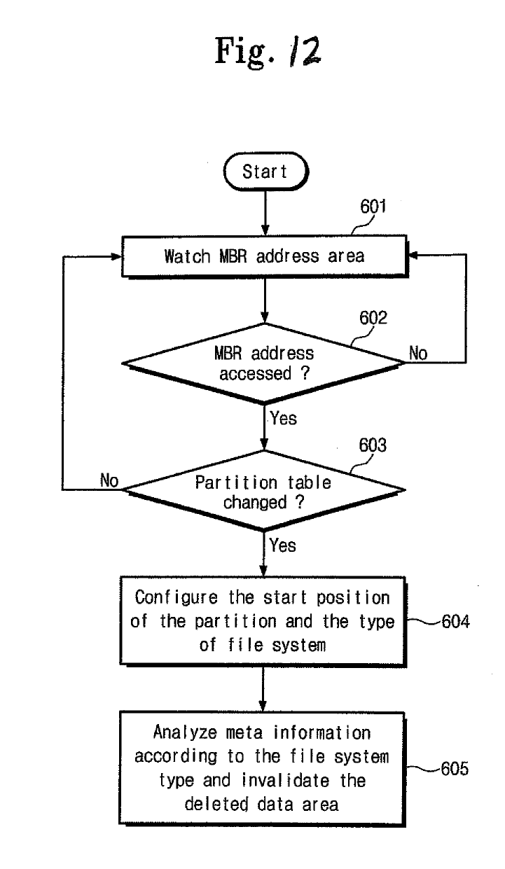

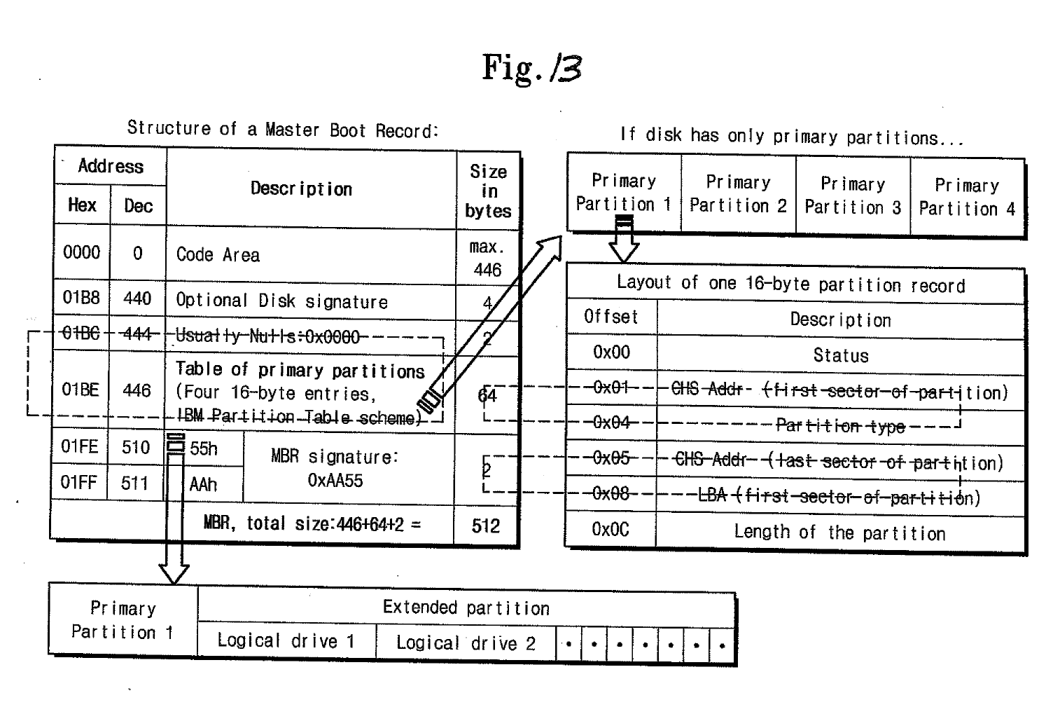

Reference is now made to FIGS. 12 and 13 with respect to method of invalidating a deleted data area of a solid state memory according to an embodiment of the present invention.

Generally, this embodiment relates to the monitoring of metadata contained in a partition table, such as the standard Table of Primary Partitions of an MBR in a BIOS system. In step 601 and 602 of FIG. 12, the MBR address area is monitored to determine whether an MBR address has been accessed. Examples of the MBR, primary partitions, and partition record are illustrated in FIG. 13.

Once it has been determined that an MBR address has been accessed, a determination is made at step 603 as to whether the Partition Table has been changed. For example, the Partition Table may be altered in the situation where a partition is divided. In this case, all data in the divided partition becomes invalid.

In the case of an affirmative determination at step 603, the start position of the partition and the type of file system (partition type) are configured in step 604 of FIG. 12. Then, at step 605, the metadata is analyzed according to the file system type, and the deleted data area is invalidated.

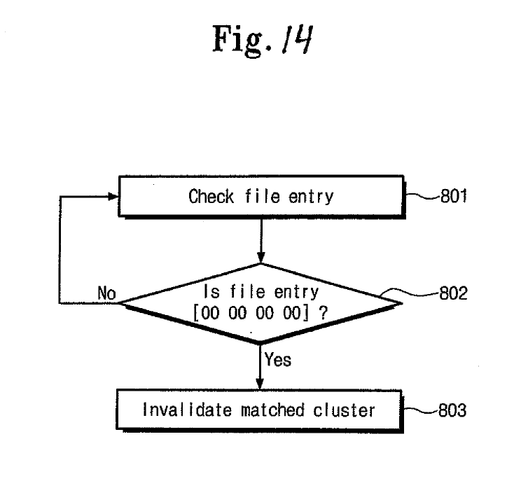

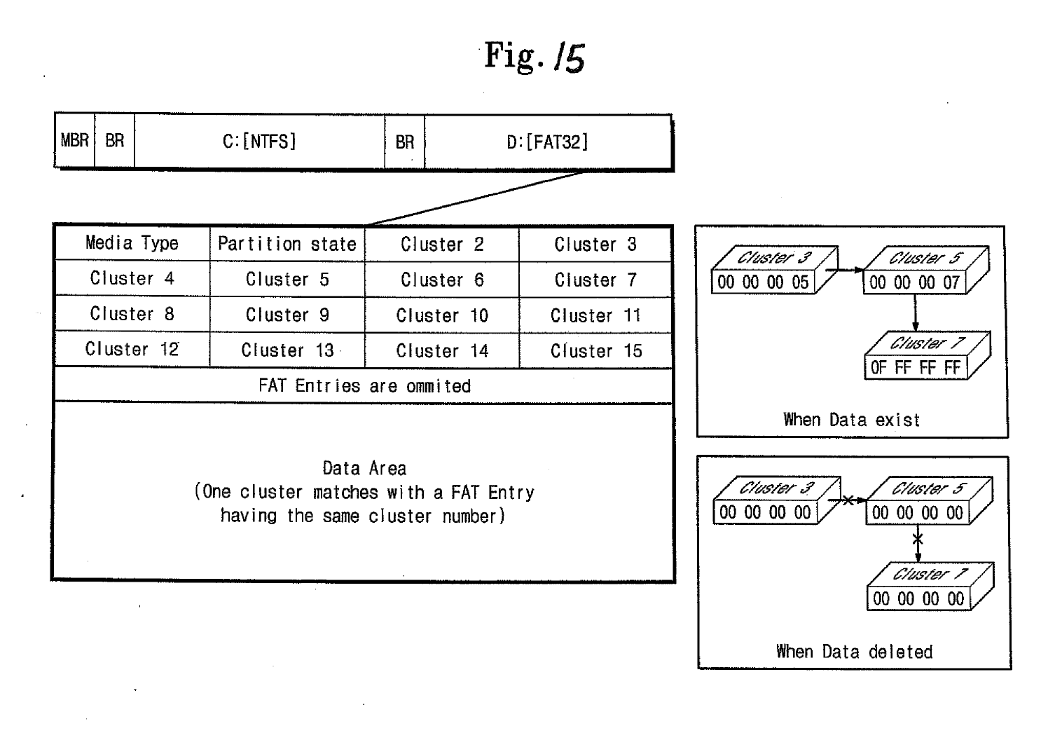

Reference is now made to FIGS. 14 and 15 with respect to method of invalidating a deleted data area of a solid state memory according to an embodiment of the present invention.

Generally, this embodiment relates to the monitoring of metadata contained in a File Allocation Table (FAT). In particular, by examining cluster linkages (or lack thereof), a determination is made as to whether data associated with the clusters is deleted data.

Generally, a file system that may be used to store files in a nonvolatile memory type solid state memory have a unit of memory allocation defined that specifies the smallest logical amount of disk space that can be allocated to hold a file. For example, the MS-DOS file system known as the File Allocation Table (FAT) calls this unit of memory allocation a cluster.

In the method of FIG. 14, the file entry is initially checked at step 801, and at step 802, a determination is made as to whether the file entry is [00 00 00 00]. If the determination at step 802 is affirmative, the matched clusters are not linked and the data thereof is invalidated at step 803.

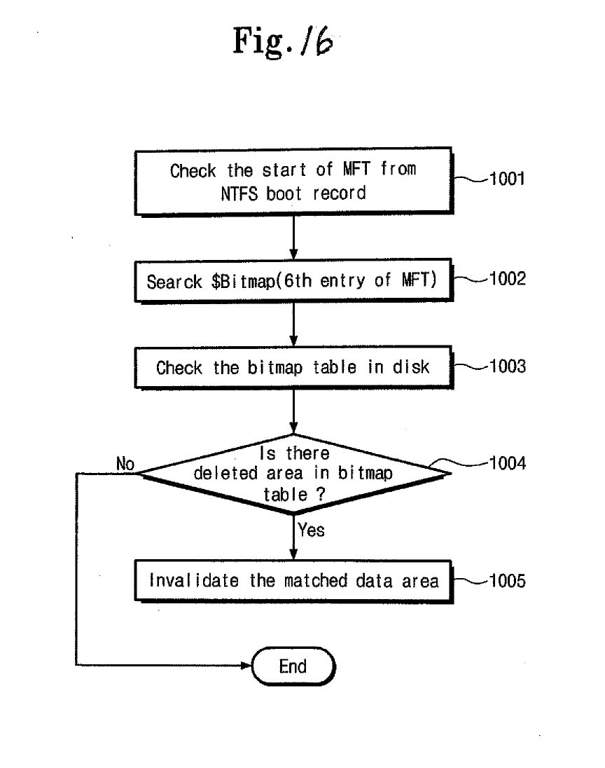

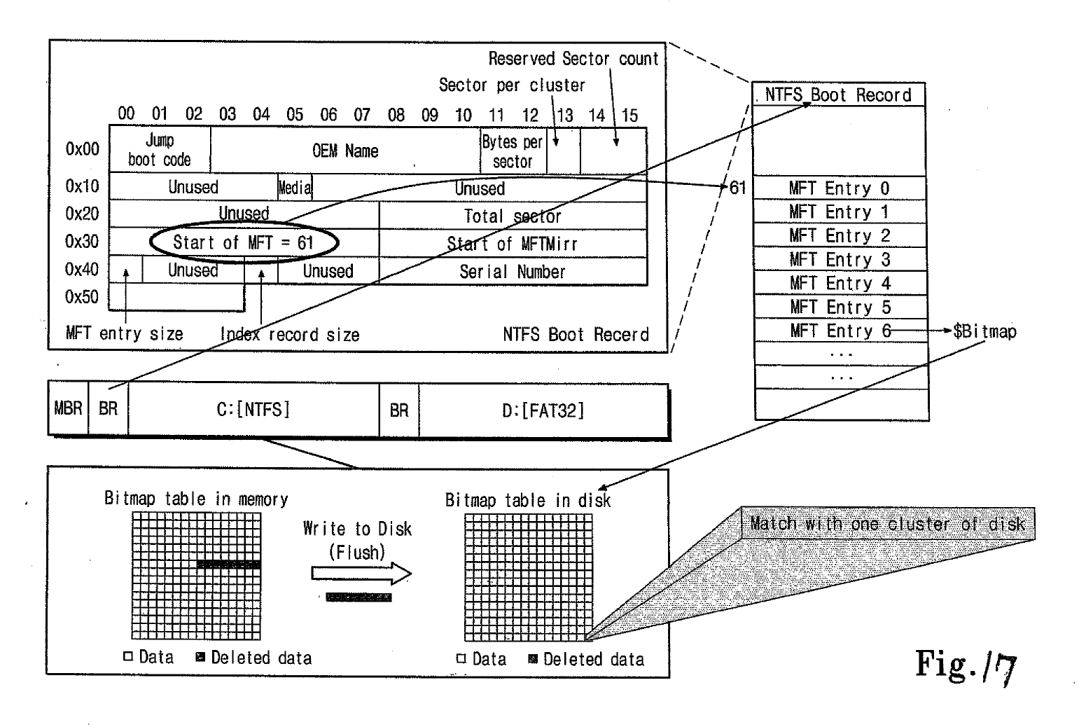

Reference is now made to FIGS. 16 and 17 with respect to method of invalidating a deleted data area of a solid state memory according to an embodiment of the present invention.

Generally, this embodiment relates to the monitoring of metadata contained in the New Technology File System (NTFS). In an initial step 1001, the start of the Master File Table (MFT) from the NTFS boot record is checked. In this example, the $Bitmap which is the sixth (6^{th}) entry of the MFT is then searched at step 1002, and then the bitmap table is checked at step 1003. A determination is then made as to whether a deleted area exists in the bitmap table at step 1004, and if the answer is affirmative, the matched data area is invalidated.

By invalidating data or data areas as described above, it becomes possible to execute a merge operation in the solid state disk (SSD) drive without copying the invalid data. In addition, for example, garbage collection systems can be made more efficient.

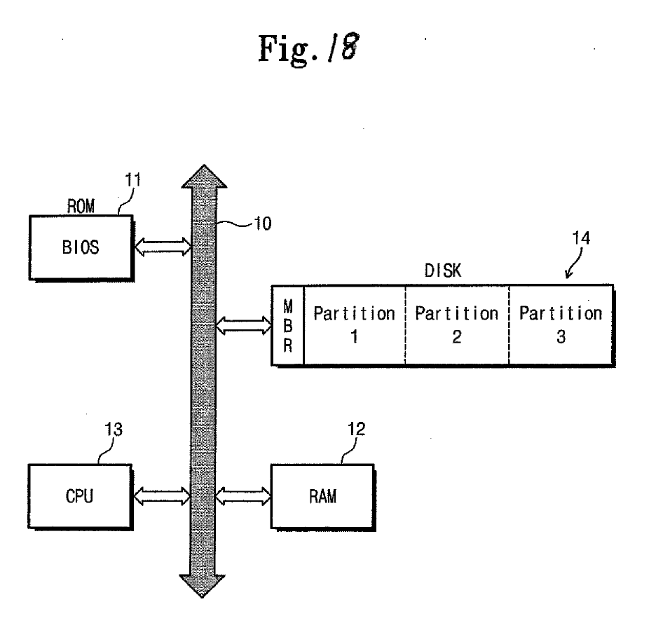

FIG. 18 is a block diagram a computer system according to an embodiment of the present invention. As shown, the computer system includes a bus system 10, and a read-only memory (ROM) 11 which is connected to the bus system 10 and stores software (e.g., BIOS) utilized to initialize the computer system. The computer system also includes a random access memory 12 which functions as a working memory, a central processing unit 13, and a solid state memory system 14 all connected to the bus system 10. The solid state memory system includes solid state memory and a controller (e.g., see FIG. 7). Also, in the example illustrated in FIG. 18, the solid state memory system includes a Master Boot Record and is logically divided into plural partitions. As described in connection with previous embodiments herein, the controller of the solid state memory system is configured to logically partition the solid state memory, update metadata of the logically partitioned solid state memory, and monitor the updated metadata to locate invalid data stored in the solid state memory system.

The above-disclosed subject matter is to be considered illustrative, and not restrictive, and the appended claims are intended to cover all such modifications, enhancements, and other embodiments, which fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A memory system, comprising:
a nonvolatile memory adapted to store a file system containing file system information; and
a controller adapted to read the file system information and perform a merge operation.

2. The system of claim 1, wherein the controller uses the file system information to selectively copy data stored in a first block of the nonvolatile memory to a second block of the nonvolatile memory during the merge operation.

3. The system of claim 2, wherein the controller selectively copies data from the first block to the second block on a page by page basis.

4. The system of claim 3, wherein, where the file system information indicates that a page of data in the first block is allocated, the controller copies the page to the second block.

5. The system of claim 3, wherein, where the file system information indicates that a page of data in the first block is deleted, the controller does not copy the page to the second block.

6. The system of claim 1, wherein the controller comprises a working memory adapted to store a translation layer for reading the file system information and performing a merge operation.

7. The system of claim 6, wherein the nonvolatile memory comprises a NAND flash memory.

8. The system of claim 1, wherein the nonvolatile memory and the controller are located in a memory card.

9. A method of performing a merge operation in a nonvolatile memory system comprising a nonvolatile memory and a controller, the method comprising:
reading file system information from a file system region of the nonvolatile memory; and
selectively copying a page from a first block in the nonvolatile memory to a second block in the nonvolatile memory based on the file system information.

10. The method of claim 9, further comprising:
before reading the file system information, converting a page of the second block into a logical page.

11. The method of claim 9, wherein selectively copying the page from the first block to the second block comprises:
determining whether the page is valid; and
determining whether the page is allocated according to the file system information.

12. The method of claim 11, further comprising:
upon determining that the page is valid and allocated according to the file system information, copying the page from the first block to the second block.

13. The method of claim 11, further comprising:
upon determining that the page is valid and not allocated according to the file system information, terminating the merge operation without copying the page from the first block to the second block.

14. The method of claim 9, further comprising:
selectively copying another page from a third block to the second block.

15. The method of claim 14, wherein the first block comprises a data block located in a data region of the nonvolatile memory;
the second block comprises a data block located in the data region of the nonvolatile memory; and,
the third block comprises a log block located in a log region of the nonvolatile memory device.

16. The method of claim 9, further comprising:
running a translation layer in a working memory of the controller to control the reading of the file system information and the selectively copying the page from the first block in the nonvolatile memory to the second block in the nonvolatile memory based on the file system information.
